(19) United States
(12) Patent Application Publication
(10) Pub. No.: US 2005/0031209 A1
(43) Pub. Date: Feb. 10, 2005

(54) Parchment craft system

(75) Inventors: Marie Browning, (US); Christopher Robert Carlson, Waterloo, WI (US); Jamieson A. Foght, Wausau, WI (US); Robert W. Cornell, Schofield, WI (US)

Correspondence Address: FOLEY & LARDNER, 321 NORTH CLARK STREET, SUITE 2800, CHICAGO, IL, 60610-4764, US

(73) Assignee: Fiskars Brands, Inc.

(21) Appl. No.: 10/836,286

(22) Filed: Apr. 30, 2004

Related U.S. Application Data
(63) Continuation-in-part of application No. 10/036,843, filed on Dec. 21, 2001.

(51) Int. Cl. G06K 9/34; G06K 9/46

(52) U.S. Cl. 382/203

(57) ABSTRACT

An embossing system for use in parchment craft creation comprising a base having a plurality of posts positioned on the outer portion thereof. One or more primary templates include a plurality of shapes formed therein and are used for embossing several features of an image. A small detail template and a stippling template are used separate from the one or more templates to create various intricate and complex designs on parchment paper or similar materials.

### CROSS-REFERENCE TO RELATED PATENT APPLICATIONS

This application is a Continuation in part of U.S. patent application Ser. No. 10/036,843, filed Dec. 21, 2001, incorporated herein by reference in its entirety.

### FIELD OF THE INVENTION

The present invention relates generally to scoring or embossing systems. More particularly, the present invention relates to a system for scoring or embossing a variety of shapes onto materials such as parchment paper and card stock.

### BACKGROUND OF THE INVENTION

Systems for embossing and describing different shapes and patterns are conventionally known. One embossing system involves placing a medium such as paper, card stock or metal foil on a table or a similar structure. A template with at least one shape formed therein is positioned atop the medium and is held in place either by an adhesive or the user's hand. The user traces the perimeter of the shape onto the medium with the use of a stylus. The template could also be used with a craft knife for cutting out the desired shape.

Another conventional embossing system involves the use of two identical and aligned templates, with both templates including identical shapes in the same position on each template. The medium is placed between the two templates, and a stylus is used to trace the shape onto the medium. An embosser including a ball bearing on the tip may also be used to trace the shape of the medium.

Although such embossing and scoring systems are generally known, conventional systems often suffer from a lack of control of the individual components. In particular, in many conventional systems the user must hold down the template or templates with one hand while scoring or embossing the shape with the other hand. In systems where the templates are clamped down, they are restrained using adhesives or similar devices which are difficult to set and reset over time.

Furthermore, in recent years one particular type of craft has become increasingly popular. This craft, commonly called parchment craft, is a creative hobby where by using different tools and materials on parchment or parchment paper, a user can create greeting cards, bookmarks, lampshades, mural decorations, realistic flowers, boxes and other projects that incorporate exceptionally elaborate and intricate designs. One type of parchment paper is sold under the Pergamano brand name. Parchment paper is very strong, allowing it to be modeled in numerous ways without suffering any significant damage. However, creating these designs is also very time consuming and tedious. Successful completion of these designs also requires a high degree of expertise on the part of the user. These factors result in the need for a system of making such designs in a simple and efficient manner.

### SUMMARY OF THE INVENTION

It is therefore an object of the invention to provide an improved embossing system that allows the user to fix the position of the individual components.

It is another object of the invention to provide an improved embossing system that permits a user to use both hands while embossing individual shapes, letters, numbers, or designs.

It is yet another object of the invention to provide an improved embossing system that permits a user to change individual templates quickly.

It is another object of the invention to provide an improved embossing system that permits a user to quickly change the individual textures that are embossed on the medium.

It is another object of the invention to provide an improved embossing system that includes detachable components for fixing the position of the embossing templates.

It is another object of the invention to provide an improved embossing system for creating intricate parchment craft designs.

It is yet another object of the invention to provide an improved embossing system for creating intricate parchment designs while minimizing the potential for misalignment.

In accordance with the above nonlimiting objects, the present invention provides for A parchment craft system for forming an image, comprising one or more primary templates with shapes formed therein for embossing several features for the image. A small detail template, also with shapes formed therein, provides details for the image to be formed. A stippling template includes a plurality of dots formed therein for providing stippling for the image to be formed.

Further advantages and features of the present invention will be apparent from the following specification, drawings and claims illustrating the preferred embodiments of the present invention.

### BRIEF DESCRIPTION OF THE DRAWINGS

FIG. 1A is an exploded view of an embossing system according to one embodiment of the present invention; and FIG. 1B is an exploded view of an embossing system according to another embodiment of the present invention;

FIG. 2 is a perspective view of an embossing system according to an alternate embodiment of the invention;

FIG. 3 is a perspective view of an embossing system according to yet another embodiment of the invention;

FIG. 4 is a top view of a lower template for use during creation of a first parchment craft design;

FIG. 5 is a top view of an upper template for use during creation of the first parchment craft design;

FIG. 6 is a top view of a small detail template for use during creation of the first parchment craft design;

FIG. 7 is a top view of a stippling detail template for use during creation of the first parchment craft design;

FIG. 8 is a layout showing an ornamental parchment design during various stages of completion of a second parchment craft design; and

FIG. 9 is a perspective view of a stylus for use in creating a parchment craft design.

### DETAILED DESCRIPTION OF THE PREFERRED EMBODIMENTS

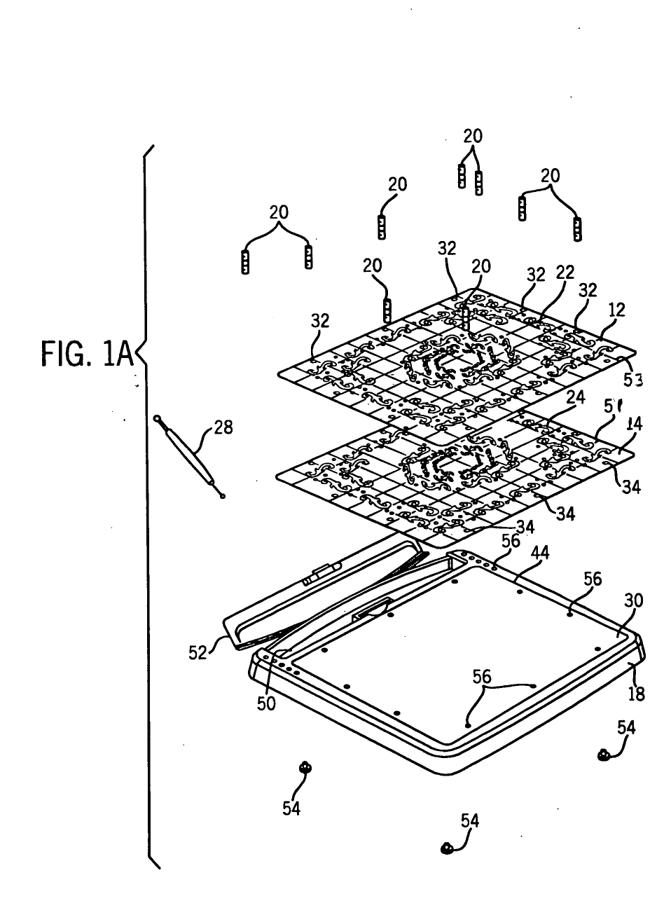

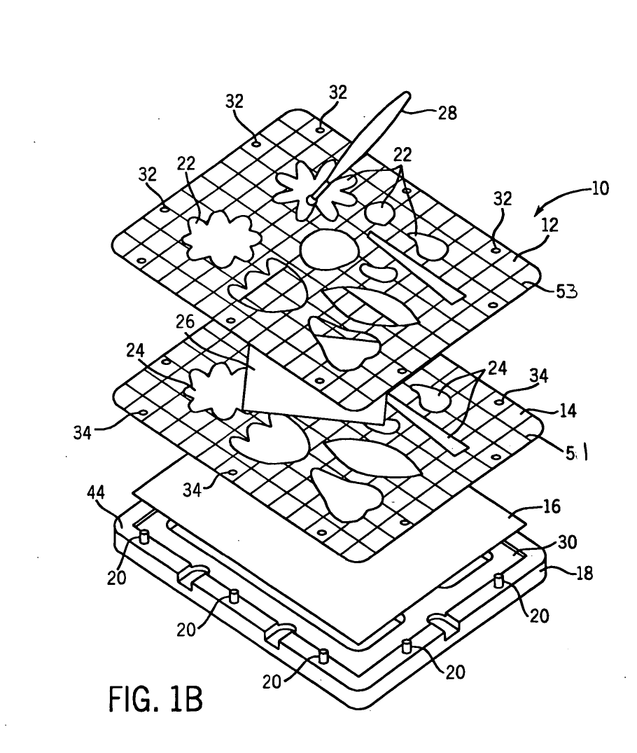

An embossing system 10 constructed in accordance with one form of the invention is generally shown in FIGS. 1A-3. The embossing system 10 includes an upper template 12 and a lower template 14. In one embodiment of the invention and as shown in FIG. 1B, a textured plate 16 is positioned generally below the lower template 14. The textured plate 16 may include a variety of textured surfaces that may include grooves, ridges, undulations, or other textures. Alternatively, the textured plate 16 may include no texture at all depending upon the user's specific needs. The upper template 12, the lower template 14 and the textured plate 16 are all removably positioned on top of a base plate 18.

The upper template 12 includes a plurality of upper template shapes 22. The upper template shapes 22 may vary greatly and could also include, for example, lettering, numbering or other designs. The lower template 14 includes a plurality of lower template shapes 24. The lower template shapes 24 may also vary but are substantially identical in both shape, size and position to the upper template shapes 22 on the upper template 12. In other words, the lower template shape 24 at a particular position on the lower template 14 is substantially identical to the upper template shape 22 at the same position on the upper template 12.

In a preferred embodiment of the invention, the upper template shapes 22, although identical to the corresponding lower template shapes 24, are slightly larger than the corresponding lower template shapes 24. The slight difference in sizes between the upper template shapes 22 and the corresponding lower template shapes 24 permit a user to make an improved, more crisp embossment along the edge of the shape to be embossed. In one particular embodiment of the invention, each upper template shape is about 0.050 larger in cross-section than the corresponding lower template shape 24.

The upper template 12, the lower template 14 and the textured plate 16 are all sized to fit on top of the base plate 18 in a close fitting relationship. As shown in FIG. 1B, the base plate 18, according to one embodiment of the invention, includes a small depression 30 which is sized such that the textured plate 16 and/or the upper template 22 and the lower template 24 fit therein.

According to a preferred embodiment of the invention, the upper template 12 and the lower template 14 matingly engage the base plate 18. This engagement is accomplished through the use of removable alignment pegs 20 positioned on the base plate 18 and corresponding upper template holes 32 and lower template holes 34, along with a plurality of base plate holes 56 located along the base plate 18. The alignment pegs 20 and the base plate holes 56 are positioned along an outer edge 44 of the base plate 18. It is also possible to have additional ones of the base plate holes 56 on the sides of the base plate 18 for storage purposes, as shown in FIG. 1A.

For each one of the alignment pegs 20, there is an upper template hole 32 and a lower template hole 34 located in an identical position on the upper template 12 and the lower template 14, respectively. The upper template holes 32 and lower template holes 34 are sized to closely fit with the alignment pegs 20 on the base plate 18. When the upper template holes 32, the lower template holes 34 and the alignment pegs 20 are in a mating engagement, the upper template 12 and the lower template 14 are impeded from moving relative to the base plate 18. This feature greatly aids the user in operating the embossing system 10 without the risk of inadvertent movement of the upper template 12 or the lower template 14. Additionally, this arrangement permits the upper template 12 and the lower template 14 from being completely removed from the base plate 18. This permits the user to use different types of templates on the same base plate 18, while also allowing the user to change the textured plate 16 depending upon the particular user needs.

According to one embodiment of the invention, the individual alignment pegs 20 are removable such that the user is able to use larger pieces of paper or other oversized mediums without bending the medium when a medium 26 is disposed inside the embossing system 10. This arrangement also permits the use of other templates of varying sizes which may or may not be provided with the embossing system 10 of the present invention.

In one embodiment of the invention, the embossing system 10 includes a storage compartment 50 with a lid 52. The storage compartment 50 and the lid 52 may be used to store a stylus 28, other marking instruments and/or the alignment pegs 20. A variety of types of locking mechanisms may be used to secure the lid 52, enclosing the storage compartment 50.

The overall size of the embossing system 10 may vary depending upon the particular user requirements. In one embodiment of the invention, the embossing system 10 will be of a size to correspond to standard 8½″ by 11″ paper. Alternatively, the embossing system 10 could be sized to better fit standard greeting cards or other paper items. The embossing system may include a plurality of feet 54 coupled to the underside of the base plate 18. The feet 54, which may be formed from rubber or other materials, prevent or impede the base plate 18 from sliding along the surface upon which the embossing system 10 is placed.

The upper template 12 and the lower template 14, according to one embodiment of the invention, are made of PET or biaxially oriented film or mylar and can be transparent and/or tinted. The upper template 12 may include a preprinted upper template grid 53, and the lower template 14 may include a preprinted lower template grid 51. The upper template grid 53 and the lower template grid 51 may be used for properly aligning the medium 26. The embossing system 10 may also include a self-healing cutting mat (not shown). The thickness of the upper template 12 and the lower template 14 may vary depending upon the particular use.

In a preferred embodiment of the invention, the lower template 14 has a thickness of about 0.010-0.020 inches and is formed from an opaque, colored plastic material. In a most preferred embodiment of the invention, the lower template 14 has a thickness of about 0.010 inches. It has been observed that when the lower template 14 has a thickness of about 0.010 inches, the medium is less likely to be torn during the embossing process than when the lower template 14 has a greater thickness. In a most preferred embodiment of the invention, the upper template 12 has a greater thickness than the lower template, and it has been found that there is improved quality in the embossment when the upper template 12 and the lower template 14 have different thicknesses. In a preferred embodiment of the invention, the upper template 12 has a thickness of about 0.015-0.020 inches, with a most preferred thickness of about 0.015 inches. Other thicknesses for the upper template 12 and the lower template 14 may be used, and it is also possible for the upper template 12 and the lower template 14 to be of substantially identical thicknesses.

The upper template 12 and the lower template 14 may be laser cut, water jet cut, die cut, or punched out of sheet material. In one particular embodiment of the invention, the base plate 18 is injection molded.

The embossing system 10 includes the stylus 28 or similar marking mechanism for embossing or scoring the medium 26. A variety of types of marking mechanisms may be used. One exemplary form of marking device includes a ball bearing at one end thereof. One such device is currently marketed under the name EMPRESSOR™. Alternatively, a pencil or other drawing instrument could be used in place of the stylus 28. The embossing system 10 can be used on a variety of medium 26 including without limitation paper, card stock, bond paper, thirty pound vellum, metal foil, and other such materials.

The operation of the embossing system 10 is generally as follows. When a user desires to emboss a particular material, the user first selects the proper textured plate 16 and locates the selected textured plate 16 within the depression 30 of the base plate 18. The user selects the particular shape to be embossed on the material, and places the lower template 14 containing that shape atop the base plate 18, aligning the lower template holes 34 with the alignment pegs 20. The user then positions the medium 26 on top of the lower template 14 in such a position as to cover the particular shape to be scored. Once the medium 26 is in a proper position, the user locates the upper template 12 on top of the medium 26 and the lower template 14, aligning the upper template holes 32 with the alignment pegs 20. The user maneuvers the stylus 28 within the particular upper template shape 22 which is to be embossed on the material 26. During this process, the user may maneuver the stylus 28 along only the outer edge of the upper template shape 22, or may maneuver it throughout the region. When the user is done maneuvering or scoring the upper template shapes 22, the user removes the upper template 12. The material 26 then includes an embossment corresponding to the upper template shape 22 and the lower template shape 24.

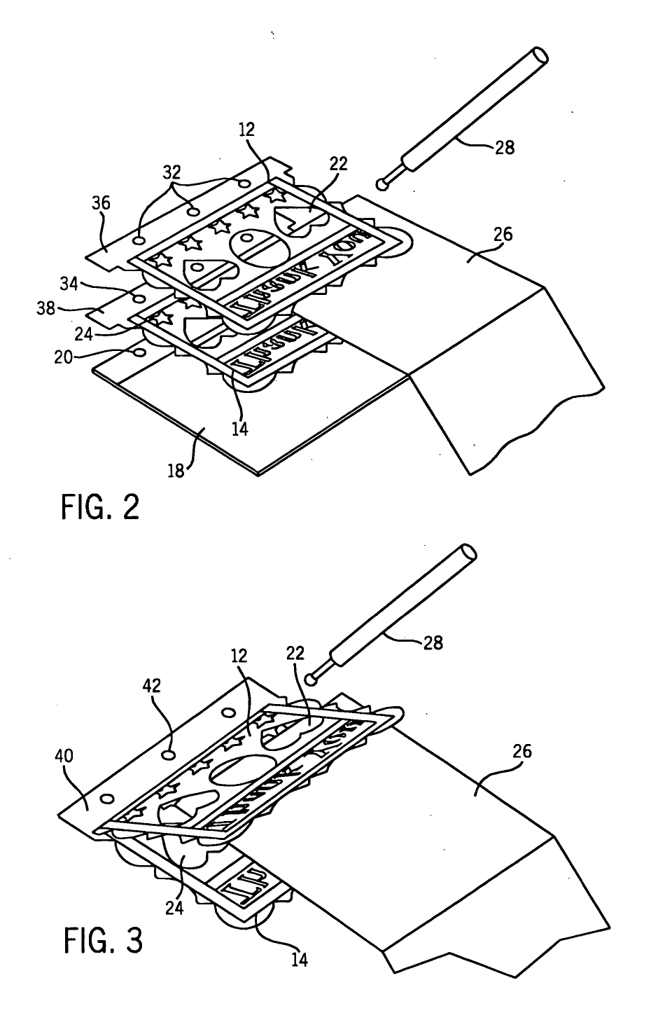

According to an alternate embodiment of the invention, and as shown in FIG. 2, the upper template 12 and the lower template 14 can be a variety of shapes and may also only include the upper template holes 32 and the lower template holes 34 on an upper template margin 36 and a lower template margin 38, respectively. Although the positioning of the individual upper template holes 32 and the lower template holes 34 can vary, the upper template holes 32 and the lower template holes 34 still operate to fix the position of the upper template 12 and lower template 14 so long as they mate with the alignment pegs 20 on the base plate 18. In one embodiment of the invention, the upper template holes 32 and the lower template holes 34 are positioned to align with the standard European and/or American binder hole arrangements.

In still another embodiment of the invention, and as shown in FIG. 3, the upper template 12 and the lower template 14 are joined together at a single margin 40 that includes margin alignment holes 42. The single margin 40 provides the user the added benefit of keeping the upper template 12 and the lower template 14 together at all times, minimizing the risk of at least one of the upper template 12 or the lower template 14 being lost. In this particular embodiment of the invention, the upper template 12 and the lower template 14 are hingedly or flexedly connected to each other such that the medium 26 can be easily positioned and removed from the embossing system 10.

In yet another embodiment of the invention, an integrated clamp (not shown) may be used to further clamp the individual components of the embossing system 10 in place. For example, the integrated clamp can be used as a ruler for measuring and alignment of the medium 26 or other items in the embossing system 10. The clamp can be spring tensioned to hold the individual components securely in place.

The embossing system 10 may also include a storage lid (not shown) sized to fit on top of the upper and the lower templates 12 and 14, the textured plate 16 and the base plate 18, mating with the alignment pegs 20 to safely secure all of the components. Additionally, a small light (not shown) may be positioned inside the depression 30. The light may be used to illuminate the medium 26 being embossed, making it easier for the user to identify whether the medium 26 has been embossed and, if so, the degree of embossment.

Additionally, in one embodiment of the invention the embossing system could be shaped and sized to operate with a shape cutting system of the type described in U.S. patent application Ser. No. 09/769,683, filed on Jan. 25, 2001, and/or U.S. patent application Ser. No. 10/632,358, filed on Aug. 1, 2003, both of which are incorporated herein by reference. In this particular embodiment, the shape cutting device and associated materials are operated on the top of the base plate 18. The alignment pegs 20 may also be of a sufficient height such that multiple templates and scoring guides from the shape cutting system could be stored with the embossing system 10, resulting in a significant space savings.

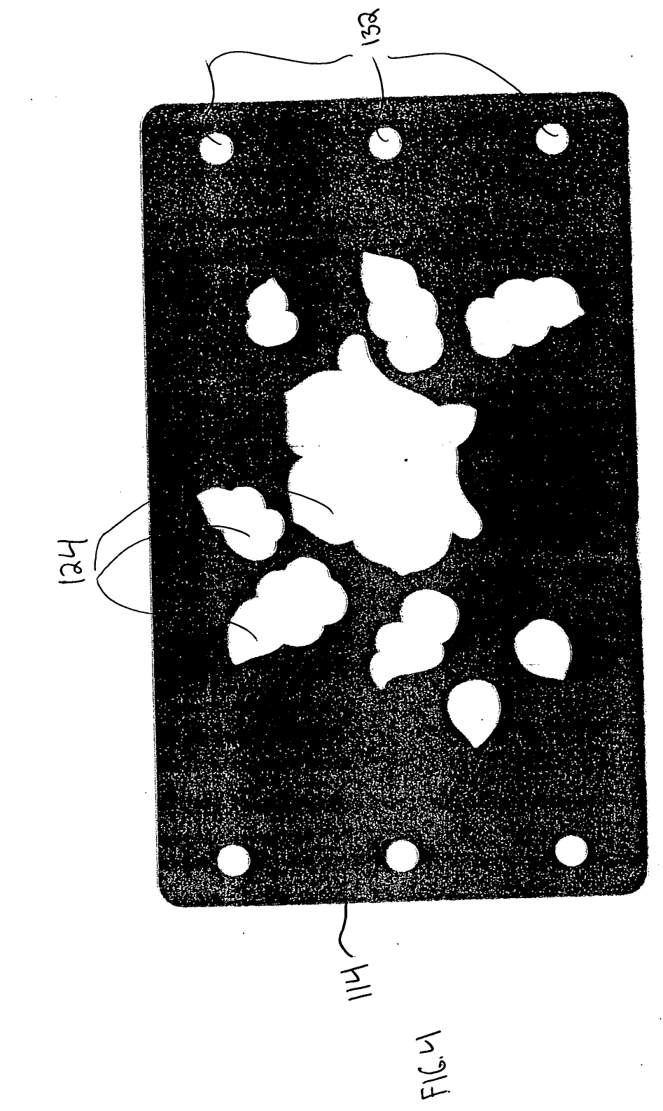

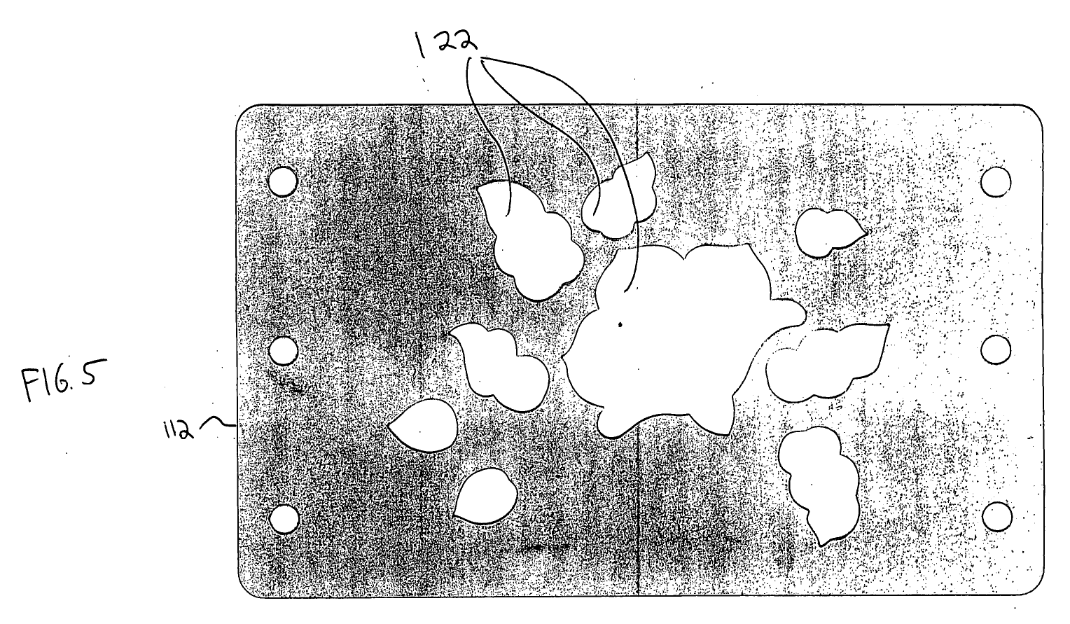

FIGS. 4-8 show another embodiment of the invention, where various parchment craft designs are formed in a simple and efficient manner. FIGS. 4 and 5 show a lower parchment template 114 and an upper parchment template 112. The upper parchment template 112 and the lower parchment template 114, according to one embodiment of the invention, are made of PET or biaxially oriented film or mylar and can be transparent and/or tinted. The thickness of the upper parchment template 112 and the lower parchment template 114 may vary depending upon the particular use. In a preferred embodiment of the invention, the lower parchment template 114 has a thickness of about 0.010-0.020 inches and is formed from an opaque, colored plastic material. In a most preferred embodiment of the invention, the lower parchment template 114 has a thickness of about 0.010 inches. In a most preferred embodiment of the invention, the upper parchment template 112 has a greater thickness than the lower parchment template 114. It has also been found that there is generally an improved quality in the embossment when the upper parchment template 112 and the lower parchment template 114 have different thicknesses. In a preferred embodiment of the invention, the upper template has a thickness of about 0.015-0.020 inches, with a most preferred thickness of about 0.015 inches. Other thicknesses for the upper parchment template 112 and the lower parchment template 114 may be used, and it is also possible for the upper parchment template 112 and the lower parchment template 114 to be of substantially identical thicknesses.

The upper parchment template 112 includes a plurality of upper parchment template shapes 122, and the lower parchment template 114 includes a plurality of lower parchment template shapes 124. The upper parchment template shapes 122, although identical to the corresponding lower parchment template shapes 124, are slightly larger than the corresponding lower parchment template shapes 124 according to a preferred embodiment of the invention.

The upper parchment template 112 and the lower parchment template 114 are used in a manner substantially identical to the upper template 12 and the lower template 14 shown in FIGS. 1A and 1B. In particular, the user selects the particular shape to be embossed on the material, and places the lower parchment template 114 containing that shape atop the base plate 18 (see FIG. 1A). When using the lower parchment template 114 and the upper parchment template 112, the user then positions the medium 26 (FIG. 1B) on top of the lower parchment template 114 in such a position as to cover the particular shape to be scored. Once the medium 26 is in a proper position, the user locates the upper parchment template 112 on top of the medium 26 and the lower parchment template 114, aligning the upper parchment template 112 properly. The user maneuvers the stylus 28 within the particular template shape which is to be embossed on the material 26. In one embodiment of the invention, a parchment craft stylus 115 of the type shown in FIG. 9 is used to complete this embossing step. The parchment craft stylus 115 includes a first end 117 and a second end 119, with the first end 117 being used for embossing and the second end 119 being used for piercing the medium 26 to create stippling, as will be later discussed.

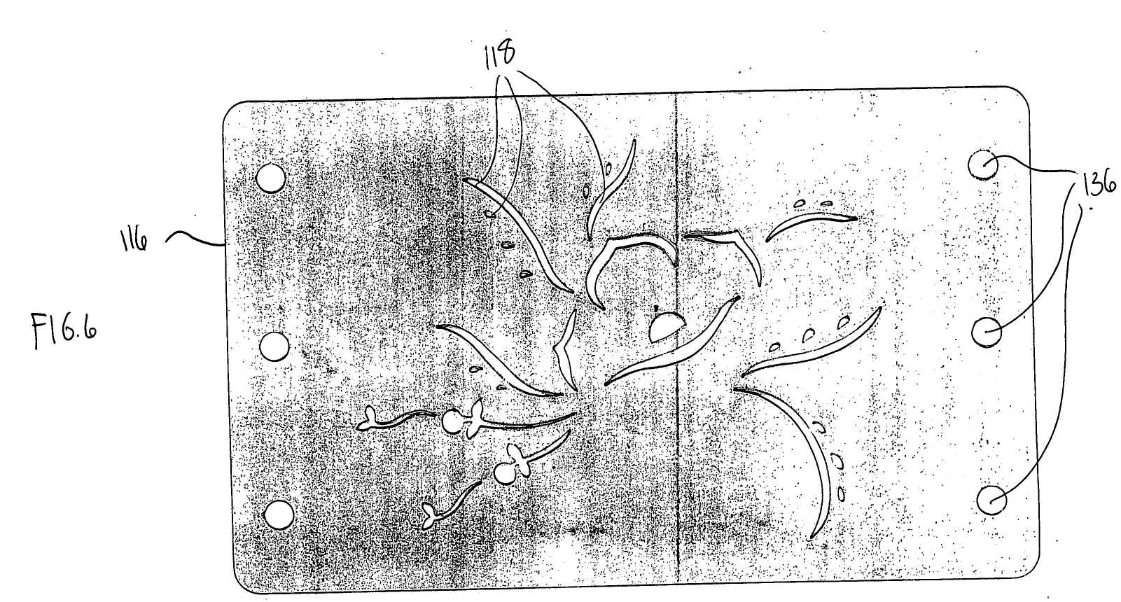

After the above step has been completed, the lower parchment template 114 and the upper parchment template 112 are removed. At this point, a small detail template 116 of type shown in FIG. 6 is positioned atop the medium 26, both of which are located on the base plate 18 (see FIG. 1A). The small detail template 116 includes a plurality of small detail openings 118 that are used to provide a series of highlights to the yet-to-be completed design. In one embodiment of the invention, a white pencil (not shown) is used instead of a stylus to make these highlights.

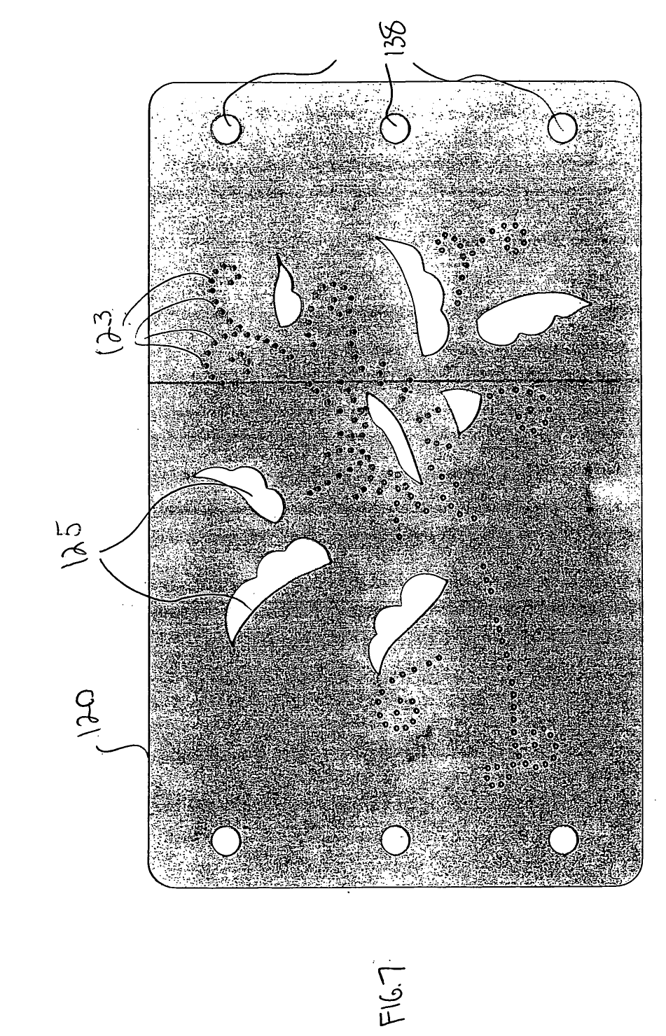

The next step involves the removal of the small detail template 116 and addition of a stippling detail template 120 of the type shown in FIG. 7. The stippling detail template 120 includes a plurality of stippling openings 123 and a plurality of secondary openings 125. The stippling detail template 120 is used to create a series of stipples (or dots) and other relatively small features in the design. In one embodiment of the invention, the second end 119 of the parchment craft stylus 115 is used to pierce the medium 26 instead of simply embossing it.

As is the case with the upper template 12 and the lower template 14 shown in FIG. 1, the upper parchment template 112 includes a plurality of upper parchment template alignment holes 132, and the lower parchment template 114 includes a plurality of lower parchment template alignment holes 134. Additionally, the small detail template 116 includes a plurality of small detail template alignment holes 136, and the stippling detail template 120 includes stippling detail template alignment holes 138. All of these holes are used to quickly and easily align the individual templates with the medium 26 as necessary.

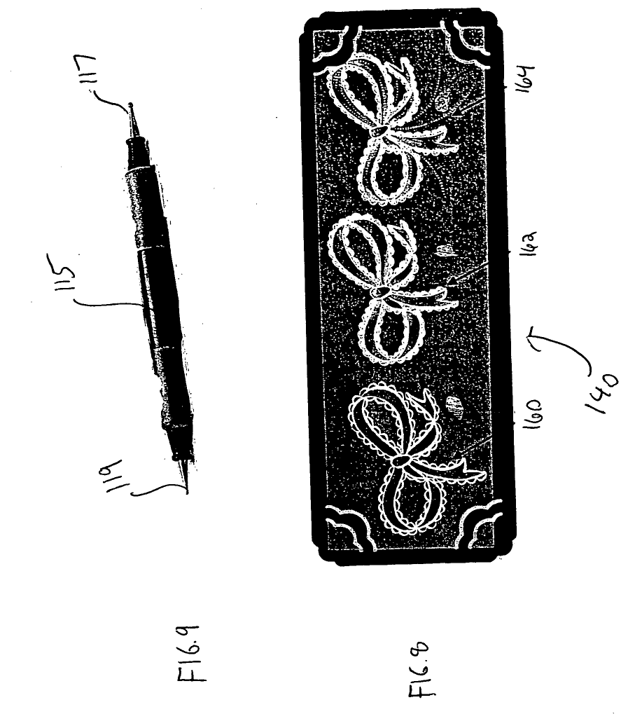

FIG. 8 shows the development of one representative design 140 according to this particular embodiment of the invention. A first image 160 shows the design after the first stage of embossing has been completed using the upper parchment template 112 and the lower parchment template 114. A second image 162 shows the design after the small detail template 116 has been used to add additional detail to the design. A third image 164 shows the completed design, after the stippling detail template 120 has been used to add the final features of the design.

In another embodiment of the invention, instead of using both the upper parchment template 112 and the lower parchment template 114 together, only one of these parchment templates is used. Additionally, the selected parchment template could be shaped and sized to operate with a shape cutting system of the type described in U.S. patent application Ser. No. 09/769,683, filed on Jan. 25, 2001, and/or U.S. patent application Ser. No. 10/632,358, filed on Aug. 1, 2003, both of which are incorporated herein by reference.

While preferred embodiments of the invention have been shown and described, it will be clear to those skilled in the art, that potential modifications can be made to the embodiments described above. For example, a variety of coupling mechanisms other than the alignment pegs 20 may be used to secure the upper and lower templates 12 and 14 to the base plate 18. Alternatively, it is possible to have the textured plate 16 mate with the alignment pegs 20 of the base plate 18. The various templates could also be used with regular cardstock paper, in addition to parchment and parchment paper, in various embodiments of the invention. Furthermore, the entire embossing system 10 can be used in the creation of cards and envelopes of various sizes. It will therefore be well understood by those in the art that modifications can be made to the above embodiments without departing from the invention in its broader aspects.

1. A parchment craft system for forming an image, comprising:
a lower template including a first shape formed therein;
a small detail template including a second shape formed therein; the third shape providing details for the image to be formed; and
a stippling template including a plurality of dots formed therein, the plurality of dots providing stippling for the image to be formed.

2. The parchment craft system of claim 1, further comprising an upper template including a third shape formed therein that aligns with the first shape of the lower template, the first and third shapes together providing primary elements for the image to be formed.

3. The parchment craft system of claim 2, wherein the upper template and the lower template are hingedly coupled to each other.

4. The parchment craft system of claim 2, wherein the upper template is of a different thickness than the lower template.

5. The parchment craft system of claim 2, wherein the lower template has a thickness of about 0.010 inches.

6. The parchment craft system of claim 2, wherein the upper template includes a preprinted grid for aligning the material upon which an image is to be created.

7. The parchment craft system of claim 1, further comprising a scoring tool of a size for use with at least the first and second plurality of shapes.

8. The parchment craft system of claim 1, wherein the lower template includes a preprinted grid for aligning the material upon which an image is to be created.

9. The parchment craft system of claim 1, further comprising:
a base; and
a plurality of posts positioned within the base,
wherein the lower template, the small detail template, and the stippling template each include a plurality of openings that correspond to the plurality of posts in order to fix the positions of the lower template, the small detail template, and the stippling template relative to the base.

10. The parchment craft system of claim 9, further comprising a textured plate positioned between the base and lower template.

11. The parchment craft system of claim 10, wherein the textured plate is removable from the base.

12. The parchment craft system of claim 9, wherein the base includes a depressed portion for accepting the lower template.

13. The parchment craft system of claim 9, wherein the base includes a lighting mechanism for illuminating at least a portion of the base during use.

14. A parchment craft system, comprising:
a base;
a lower template including a first shape formed therein,
a small detail template including a second shape formed therein; the third shape providing details for an image to be formed; and
a stippling template including a plurality of dots formed therein, the plurality of dots providing stippling for the image to be formed.

15. The parchment craft system of claim 14, further comprising an upper template including a third shape formed therein that aligns with the first shape of the lower template.

16. The parchment craft system of claim 16, wherein the base includes a plurality of posts for selectively engaging a plurality of openings on the upper template, the lower template, the small detail template and the stippling template.

17. The embossing system of claim 14, further comprising a textured plate positioned between the base and lower template.

18. The parchment craft system of claim 17, wherein the textured plate is removable from the base.

19. The parchment craft system of claim 14, further comprising a scoring tool of a size to fit within the shape of the lower template.

20. The parchment craft system of claim 19, wherein the scoring tool includes a piercing point for piercing a material through the stippling template.

21. The parchment craft system of claim 15, wherein the upper template and the lower template are hingedly coupled to each other.

22. The parchment craft system of claim 14, wherein the base includes a depressed portion for accepting the lower template.

23. The parchment craft system of claim 15, wherein the upper template is of a different thickness than the lower template.

24. The parchment craft system of claim 15, wherein the upper template includes a preprinted grid for aligning the material to be embossed.

25. The parchment craft system of claim 14, wherein the lower template includes a preprinted grid for aligning the material to be embossed.

26. A device for manipulating materials, comprising:
an embossing template including a plurality of shapes;
a base;
a small detail template;
a stippling template; and
means for selectively coupling the embossing template, the small detail template and the stippling template to the base.

27. The device of claim 26, wherein the base includes a depression for accepting and positioning a textured plate.

28. The device of claim 26, wherein the coupling means includes a plurality of pegs coupled to the base, the plurality of pegs mating with holes in the embossing template, the small detail template and the stippling template.

29. The device of claim 28, wherein the plurality of pegs are removably connected to the base.
